(19) United States
(12) Patent Application Publication
(10) Pub. No.: US 2025/0231609 A1
(43) Pub. Date: Jul. 17, 2025

(54) Systems and Methods for Power Management in Network Devices

(71) Applicant: Cisco Technology, Inc., San Jose, CA (US)

(72) Inventors: Kabiraj Sethi, Fremont, CA (US); Lakshmi Narayana Jayanthi, Dublin, CA (US); Andrew Lu, San Jose, CA (US); Ramesh Yeevani-Srinivas, Fremont, CA (US); Muhammad Imam, San Ramon, CA (US)

(21) Appl. No.: 18/414,328

(22) Filed: Jan. 16, 2024

(51) Int. Cl. H04L 12/12; G06F 1/3287; G06F 9/4401

(52) U.S. Cl. CPC G06F 1/3287; G06F 9/4418; H04L 12/12; Y02D 10/00

(57) ABSTRACT

Devices, networks, systems, methods, and processes for power saving are described herein. A device may receive a power saving signal from. The device can identify and store a memory location of a boot image. The device can switch to a power saving mode. The power saving mode can be a hibernation mode or a sleep mode. In the hibernation mode, the device can shut down one or more ports and one or more functional circuits. In the sleep mode, the device can maintain a reachable port in an operational state. The reachable port may be identified by the device based on an Internet Protocol (IP) address of a network controller. The device can switch from the power saving mode to an operational mode after receiving a wake-up signal from one or more of: the network controller, a timer within the device, or a mode button on the device.

The present disclosure relates to communication networks. More particularly, the present disclosure relates to applying power saving modes for network devices in the communication networks.

### BACKGROUND

Communication networks generally include a large number of interconnected network devices such as servers, switches, and routers. These network devices may remain powered on even during non-peak hours when utilization of the network devices is minimal. Such unnecessary power consumption may lead to increased operational costs and adverse environmental impacts. One of the common methods of reducing power consumption is scheduling the network devices to shut down or to operate in sleep or hibernation modes in the non-peak hours. By shutting down the network devices or by switching the network devices into the sleep or hibernation modes during the non-peak hours, the communication networks can achieve energy savings ranging from 60% to 80% of total power consumption. Since operating in reduced functionality modes during periods of reduced activity has minimal impact on business functions, more organizations are now willing to adopt more power saving techniques, especially in regions of world that face power crisis.

Usually, for scheduled shut down of the network devices or for scheduling the network devices to switch to sleep or hibernation modes at predefined time periods, the network devices require additional hardware such as a specialized System on Chip (SoC). The SoC includes a management port that facilitates shutting down a network device or switching the network device to sleep or hibernation modes. However, while the network device is shut down or put into the sleep or hibernation modes, the network device powers down front panel ports of the network device that are connected to other network devices in the communication network. This may lead to limited Layer 3 reachability and pose challenges for high-end switches where a more versatile and scalable deployment solution is required. Further, reliance on the management port for waking up the switches is not suitable for large-scale and high-performance networks. Moreover, requiring the use of additional hardware renders the conventional techniques unusable for implementation in existing networks of switches where infrastructure has already been deployed.

Therefore, there is a need for a flexible power saving technique that provides versatility in waking up the network devices and maintaining the Layer 3 connectivity while achieving significant reductions in power consumption.

### SUMMARY OF THE DISCLOSURE

Systems and methods for applying power saving modes for network devices in communication networks in accordance with embodiments of the disclosure are described herein.

In some embodiments, a power management logic may be configured to receive a power saving signal indicative of entering a power saving mode, identify a boot image, determine a memory location associated with the boot image, shut down one or more components of the device based on the power saving signal to enter the power saving mode, receive a wake-up signal during the power saving mode, and retrieve the boot image from the memory location based on the wake-up signal.

In some embodiments, the power management logic is further configured to reboot the device based on the boot image, and restart the one or more components of the device.

In some embodiments, the one or more components include one or more cores of an Application-Specific Integrated Circuit (ASIC) in the device.

In some embodiments, the one or more components include one or more ports of the device.

In some embodiments, the power management logic is further configured to shut down the one or more ports and the one or more cores of the ASIC when the power saving mode is a hibernation mode.

In some embodiments, the wake-up signal is received during the hibernation mode through a management port coupled to the processor.

In some embodiments, the power saving signal is indicative of a power saving start time and a wake-up time.

In some embodiments, the power management logic is further configured to determine a power saving duration based on the power saving start time and the wake-up time, and initialize a timer based on the power saving duration.

In some embodiments, the timer generates the wake-up signal after the power saving duration.

In some embodiments, the power management logic is further configured to identify a reachable port on a front panel of the device.

In some embodiments, the power management logic is further configured to maintain the reachable port in an operational state when the power saving mode is a sleep mode.

In some embodiments, the wake-up signal is received during the sleep mode through the reachable port.

In some embodiments, the power management logic is further configured to identify an Internet Protocol (IP) address associated with a controller, identify one or more Virtual Local Area Networks (VLANs) associated with the IP address, identify one or more ports associated with the one or more VLANs, and select one port of the one or more ports having lowest speed as the reachable port.

In some embodiments, the IP address associated with the controller is determined based on a configuration of the device.

In some embodiments, the IP address associated with the controller is retrieved from telemetry data received by the device.

In some embodiments, the wake-up signal is generated by a mode button coupled with the device.

In some embodiments, a power saving signal indicative of entering a power saving mode may be received, a boot image may be identified, a memory location associated with the boot image, may be determined, one or more components of a device may be shut down based on the power saving signal for entering the power saving mode, a wake-up signal received during the power saving mode, and the boot image may be retrieved from the memory location based on the wake-up signal.

In some embodiments, the device may be rebooted based on the boot image, and the one or more components of the device may be restarted.

In some embodiments, a power management logic is configured to receive a power saving signal indicative of entering a power saving mode, shut down one or more ports of the device based on the power saving signal to enter the power saving mode, and receive a wake-up signal from a controller during the power saving mode through a reachable port of the one or more ports.

In some embodiments, the power management logic is further configured to identify an Internet Protocol (IP) address associated with the controller, identify one or more Virtual Local Area Networks (VLANs) associated with the IP address, identify the one or more ports associated with the one or more VLANs, select one port of the one or more ports having lowest speed as the reachable port, and maintain the reachable port in an operational state during the power saving mode.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of switching a network device into a hibernation mode, in accordance with various embodiments of the disclosure;

FIG. 2 is a conceptual illustration of switching a network device into a sleep mode, in accordance with various embodiments of the disclosure;

FIG. 3 is a conceptual illustration of switching a network device in a communication network into a hibernation mode or a sleep mode, in accordance with various embodiments of the disclosure;

FIG. 4 is a conceptual network diagram of various environments that a power management controller may operate on a plurality of network devices, in accordance with various embodiments of the disclosure;

FIG. 5 is a flowchart depicting a process for switching a network device in a hibernation mode or a sleep mode, in accordance with various embodiments of the disclosure;

FIG. 6 is a flowchart depicting a process for identifying a reachable port when the network device is in a sleep mode, in accordance with various embodiments of the disclosure;

FIG. 7 is a flowchart depicting a process for operating a network device in a power saving mode, in accordance with various embodiments of the disclosure;

FIG. 8 is a flowchart depicting a process for switching a network device into an operational mode, in accordance with various embodiments of the disclosure; and

FIG. 9 is a conceptual block diagram of a device suitable for configuration with a power management logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that switch network devices in a communication network in one or more power saving modes. In many embodiments, a network device may receive a power saving signal. The power saving signal can be indicative of entering a power saving mode. Examples of the power saving modes include, but are not limited to, a sleep mode or a hibernation mode. The network device may include a plurality of ports, such as but not limited to, a management port and one or more front panel ports, for e.g., Ethernet ports. The network device can also include a plurality of functional circuits, such as one or more Application-Specific Integrated Circuit (ASIC) cores. In some embodiments, for example, when the network device is in the hibernation mode, all functional circuits of the network device may be shut down. In certain embodiments, for example, when the network device is in the sleep mode, a front panel port identified as a reachable port and one or more functional circuits associated with the reachable port may be operational while remaining ports and functional circuits can be shut down.

In a number of embodiments, the network device can identify a boot image subsequent to receiving the power saving signal. The boot image may include a specific set of instructions and data that are essential for booting the network device. The boot image can include an initial code required to launch an operating system of the network device and to initiate the one or more functional circuits of the network device. In some embodiments, the boot image may be a currently loaded image when the network device receives the power saving signal. The network device can store the boot image in a memory. The stored boot image may be utilized by the network device for waking up from the power saving mode. The network device can determine a memory location corresponding to the stored boot image. The network device may store a boot image name corresponding to the stored boot image and the memory location of the boot image in a Non-Volatile Random-Access Memory (NVRAM) or Electrically Erasable Programmable Read-Only Memory (EEPROM). Hence, the network device can retrieve the boot image name and the memory location from the NVRAM or EEPROM after waking up from the power saving mode. Thereafter, the network device may enter the power saving mode. In certain embodiments, the network device can enter the hibernation mode by shutting down all front panel ports and functional circuits. In more embodiments, the network device may enter the sleep mode by shutting down all ports and functional circuits except for the reachable port and a functional circuit associated with the reachable port.

In various embodiments, the network device may receive a wake-up signal. If the network device is in the hibernation mode, the network device can receive the wake-up signal on a management port coupled to a processor of the network device. If the network device is in the sleep mode, the network device may receive the wake-up signal on the reachable port. Subsequent to receiving the wake-up signal, the network device can retrieve the boot image name and the memory location from the NVRAM or the EEPROM. The network device can retrieve the stored boot image from the memory based on the boot image name and the memory location. The network device may reboot based on the boot image. The network device can restart the ports and the functional circuits that had been shut down.

In additional embodiments, the power saving signal and the wake-up signal can be generated by a network controller. The power saving signal can be indicative of a power saving start time and a wake-up time. The power saving start time and the wake-up time may be configured by the network controller based on non-peak hours or periods of reduced activity of the network device. The network controller may facilitate an operator to modify or change the power saving start time and the wake-up time. The network controller can also wake-up the network device at any time during the power saving mode by dynamically transmitting the wake-up signal to the network device. The network device can receive the power saving signal and determine a power saving duration based on the power saving start time and the wake-up time. The network device may thereafter initialize a timer based on the power saving duration. The timer can be configured to generate the wake-up signal after the power saving duration. The processor in the network device may receive the wake-up signal and reboot the network device. In some embodiments, the network device may comprise a physical mode button coupled to the processor. The mode button can generate the wake-up signal when pressed, i.e., the network device may be rebooted by pressing the mode button. Hence, the network device may receive the wake-up signal from one or more of the network controller, the mode button, or the timer.

In further embodiments, after receiving the wake-up signal, the network device can retrieve the boot image name and the memory location from the NVRAM or the EEPROM. Thereafter, the network device may retrieve the boot image from the memory location. The network device can load and execute the boot image retrieved from the memory. The network device may reboot based on the boot image. The network device can identify the one or more ports or functional circuits that had been shut down. The network device may restart or initiate the one or more ports or functional circuits.

In many more embodiments, before entering the sleep mode, the network device may identify the reachable port. To identify the reachable port, the network device can first identify which port is coupled to the network controller. For that, the network device may identify an Internet Protocol (IP) address associated with the network controller. The IP address may be utilized for communication between the network device and the network controller. The IP address can be retrieved from telemetry data received by the network device and the network controller. The IP address may also be stored in the memory of the network device. Thereafter, the network device can identify one or more Virtual Local Area Networks (VLANs) associated with the IP address. The network device may identify one or more ports associated with the one or more VLANs. The network device can determine speeds of the one or more ports and select a port with lowest speed as the reachable port. The network device may thereafter identify one or more cores of the ASIC coupled to the reachable port. The network device can maintain the identified one or more cores of the ASIC and the reachable port in an operational state, i.e., powered on, during the sleep mode.

Advantageously, the power saving technique of the present disclosure provides flexibility in entering and exiting various power saving modes, such as the hibernation mode and the sleep mode. The network device can maintain Layer 3 connectivity during the power saving modes. The network device may achieve significant reductions in power consumption during the power saving modes.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

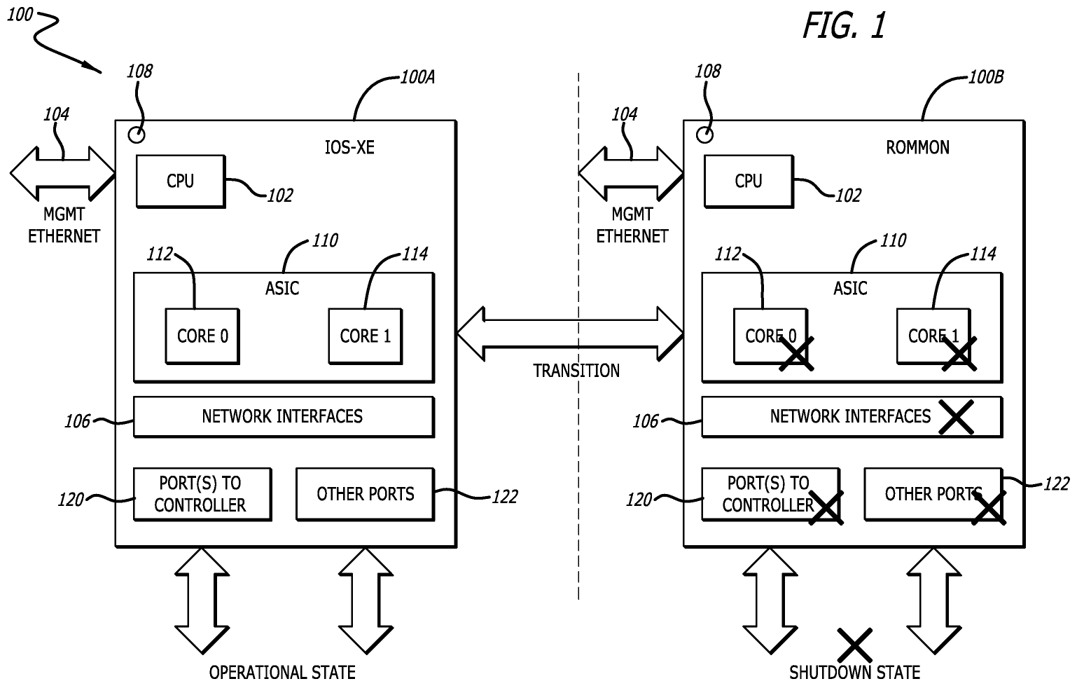

Referring to FIG. 1, a conceptual illustration of switching a network device 100 into a hibernation mode 100B, in accordance with various embodiments of the disclosure is shown. In many embodiments, the network device 100 may include a processor 102 coupled to a management port 104, network interfaces 106, a mode button 108, and an Application-Specific Integrated Circuit (ASIC) 110 including a first core 112 and a second core 114. The network interfaces 106 may be coupled to one or more ports 120 and 122. In some embodiments, the ports 120 may be connected to the network controller. The ports 120 and 122 can be Ethernet ports.

In a number of embodiments, initially, the network device 100 can be in an operational mode 100A. The processor 102 in the network device 100 may receive a power saving signal from the network controller through the management port 104. Upon receiving the power saving signal, the processor 102 can shut down the ASIC 110, the network interfaces 106 and the ports 120 and 122 to enter the hibernation mode 100B.

In various embodiments, the network device 100 can identify a boot image subsequent to receiving the power saving signal and store the boot image in a memory. The network device 100 can determine a memory location corresponding to the saved boot image. The network device 100 may store a boot image name corresponding to the boot image and the memory location of the boot image in a Non-Volatile Random-Access Memory (NVRAM) or Electrically Erasable Programmable Read-Only Memory (EEPROM). Thereafter, the network device 100 may enter the hibernation mode 100B.

In additional embodiments, the processor 102 in the network device 100 may receive a wake-up signal from the network controller through the management port 104. In some embodiments, the processor 102 can receive the wake-up signal through the mode button 108. In certain embodiments, the processor 102 can receive the wake-up signal from a timer from within the network device 100. The network device 100 can retrieve the boot image name and the memory location from the NVRAM or the EEPROM. The network device 100 may reboot based on the boot image stored in the memory. The network device 100 can restart the ASIC 110, the network interfaces 106 and the ports 120 and 122.

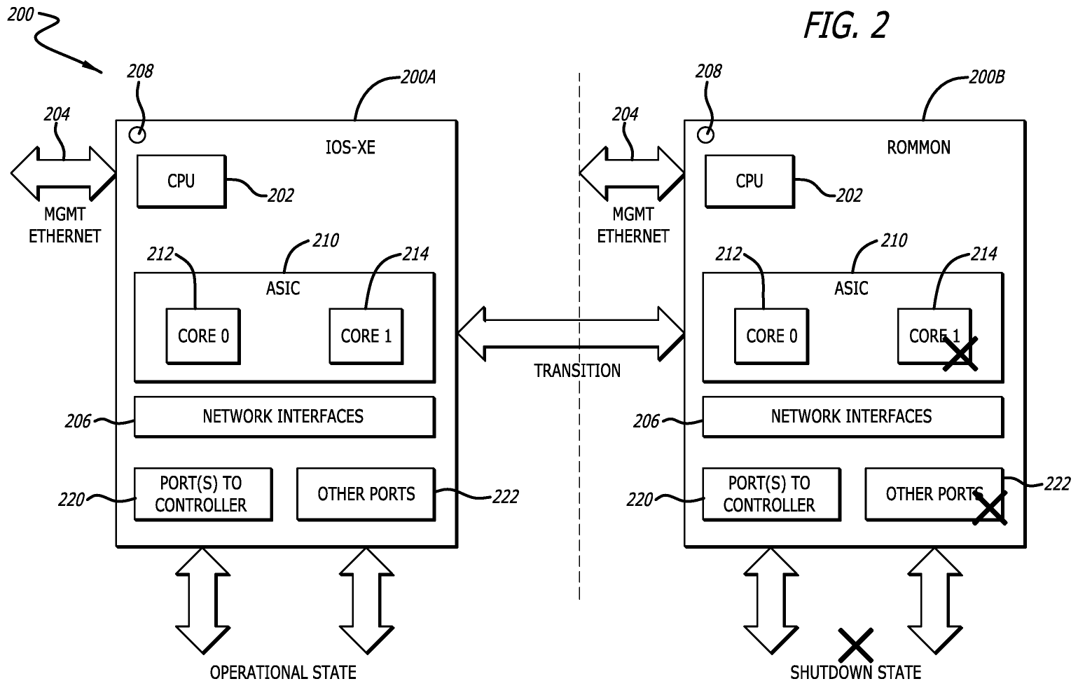

Although a specific embodiment for switching a network device 100 into the hibernation mode 100B for carrying out the various steps, processes, methods, and operations described herein is discussed with respect to FIG. 1, any of a variety of systems and/or processes may be utilized in accordance with embodiments of the disclosure. For example, the network device 100 may dynamically switch between the operational mode 100A and the hibernation mode 100B. The elements depicted in FIG. 1 may also be interchangeable with other elements of FIGS. 2-9 as required to realize a particularly desired embodiment.

Referring to FIG. 2, a conceptual illustration of switching a network device 200 into a sleep mode 200B, in accordance with various embodiments of the disclosure is shown. In many embodiments, the network device 200 may include a processor 202 coupled to a management port 204, network interfaces 206, a mode button 208, and an ASIC 210 including a first core 212 and a second core 214. The network interfaces 206 may be coupled to one or more ports 220 and 222. In some embodiments, the ports 220 may be connected to the network controller. The ports 220 and 222 can be Ethernet ports.

In a number of embodiments, initially, the network device 200 can be in an operational mode 200A. The processor 202 in the network device 200 may receive the power saving signal from the network controller through the management port 204. Upon receiving the power saving signal, the processor 202 can shut down the second core 214, and the ports 122 to enter the sleep mode 200B. The network device may maintain Layer 3 connectivity to the network controller through the ports 220 that remain powered on during the sleep mode.

Although a specific embodiment for switching the network device 200 into the sleep mode 200B for carrying out the various steps, processes, methods, and operations described herein is discussed with respect to FIG. 2, any of a variety of systems and/or processes may be utilized in accordance with embodiments of the disclosure. For example, the network device 200 may dynamically switch between the operational mode 200A and the sleep mode 200B. The elements depicted in FIG. 2 may also be interchangeable with other elements of FIG. 1 and FIGS. 3-9 as required to realize a particularly desired embodiment.

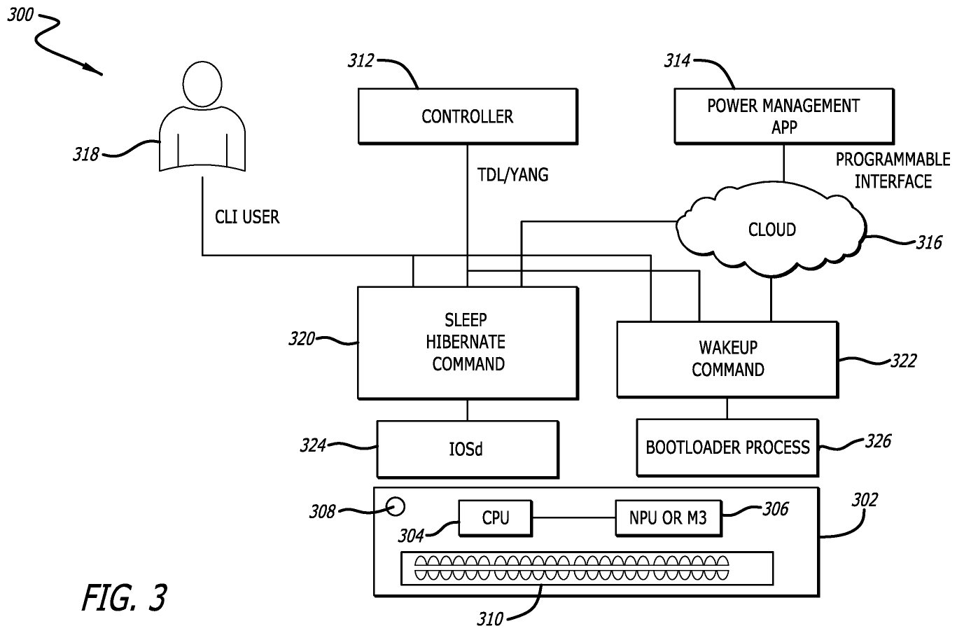

Referring to FIG. 3, a conceptual illustration of switching a network device 302 in a communication network 300 into a hibernation mode or a sleep mode, in accordance with various embodiments of the disclosure is shown. In many embodiments, the network device 302 may include a Central Processing Unit (CPU) 304, a Network Processing Unit (NPU) 306, a mode button 308, and a plurality of front panel ports 310. The network device 302 may be in communication with a network controller 312. The network device 302 can further be in communication with a cloud-based power management controller 314 through a cloud-based network 316. The network device 302 can include an Internetwork Operating System (IOS) daemon (IOSd) 324 and a bootloader process 326 stored in a memory.

In a number of embodiments, the network device 302 may receive the power saving signal 320 from the network controller 312 or the cloud-based power management controller 314. The power saving signal 320 can be indicative of a sleep command or a hibernate command. The network device can enter the sleep mode or the hibernation mode based on the power saving signal 320. The network device 312 may shut down the NPU 306 and/or the front panel ports 310 in the sleep mode or the hibernation mode. Thereafter, in some embodiments, the network device 302 can further receive the wake-up signal 322 from the network controller 312 or the cloud-based power management controller 314. In certain embodiments, the network device 302 may receive the wake-up signal 322 by way of the mode button 308. In more embodiments, the wake-up signal 322 can be generated by an internal timer in the network device 302. The network device 302 may reboot based on the wake-up signal 322. The network device 302 can restart the NPU 306 and/or the front panel ports 310 after/during reboot.

Although a specific embodiment for switching the network device 302 into the sleep mode or the hibernation mode for carrying out the various steps, processes, methods, and operations described herein is discussed with respect to FIG. 3, any of a variety of systems and/or processes may be utilized in accordance with embodiments of the disclosure. For example, the network device 302 may be a Silicon 1 (S1) based switch or a Doppler Unified Access Data Plane (UADP) based switch. The elements depicted in FIG. 3 may also be interchangeable with other elements of FIGS. 1-2 and FIGS. 4-9 as required to realize a particularly desired embodiment.

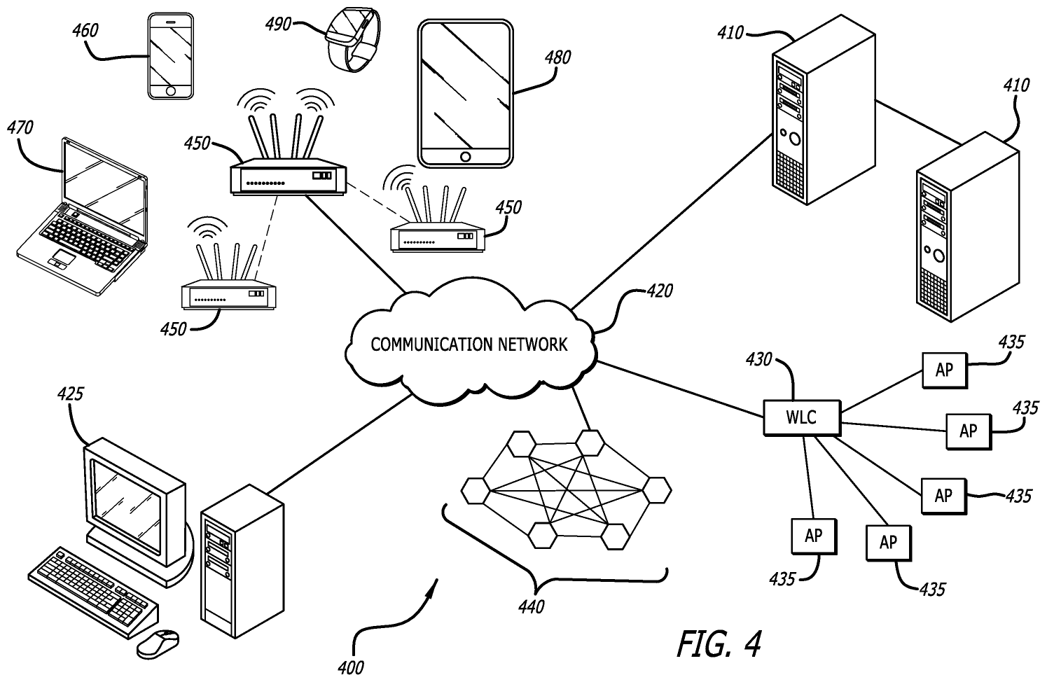

Referring to FIG. 4, a conceptual network diagram 400 of various environments that a power management controller may operate on a plurality of network devices, in accordance with various embodiments of the disclosure is shown. Those skilled in the art will recognize that the power management controller can be comprised of various hardware and/or software deployments and can be configured in a variety of ways. In many embodiments, the power management controller can be configured as a standalone device, exist as a logic in another network device, be distributed among various network devices operating in tandem, or remotely operated as part of a cloud-based network management tool. In further embodiments, one or more servers 410 can be configured with or otherwise operate the power management controller. In many embodiments, the power management controller may operate on one or more servers 410 connected to a communication network 420. The communication network 420 can include wired networks or wireless networks. In many embodiments, the communication network 420 may be a Wi-Fi network operating on various frequency bands, such as, 2.4 GHz, 5 GHZ, or 6 GHz. In further embodiments, the power management controller operating on the servers 410 can switch the devices in the communication network 400 in the power saving mode. The power management controller can be provided as a cloud-based service that can service remote networks, such as, but not limited to a deployed network 440. In many embodiments, the power management controller can be a logic that detects switches one or more devices or network devices into various power saving modes.

However, in additional embodiments, the power management controller may be operated as a distributed logic across multiple network devices. In the embodiment depicted in FIG. 4, a plurality of APs 450 can operate as the power management controller in a distributed manner or may have one specific device operate as the power management controller for all of the neighboring or sibling APs 450. The APs 450 facilitate Wi-Fi connections for various electronic devices, such as but not limited to mobile computing devices including laptop computers 470, cellular phones 460, portable tablet computers 480 and wearable computing devices 490.

In further embodiments, the power management controller may be integrated within another network device. In the embodiment depicted in FIG. 4, a wireless LAN controller (WLC) 430 may have an integrated power management controller that the WLC 430 can use to switch the power saving modes in the various APs 435 that the WLC 430 is connected to, either wired or wirelessly. In still more embodiments, a personal computer 425 may be utilized to access and/or manage various aspects of the power management controller, either remotely or within the network itself. In the embodiment depicted in FIG. 4, the personal computer 425 communicates over the communication network 420 and can access the power management controller of the servers 410, or the network APs 450, or the WLC 430.

Although a specific embodiment for various environments that the power management controller may operate on a plurality of network devices suitable for carrying out the various steps, processes, methods, and operations described herein is discussed with respect to FIG. 4, any of a variety of systems and/or processes may be utilized in accordance with embodiments of the disclosure. In many non-limiting examples, the power management controller may be provided as a device or software separate from the network devices or the power management controller may be integrated into the network devices. The elements depicted in FIG. 4 may also be interchangeable with other elements of FIGS. 1-3 and 5-9 as required to realize a particularly desired embodiment.

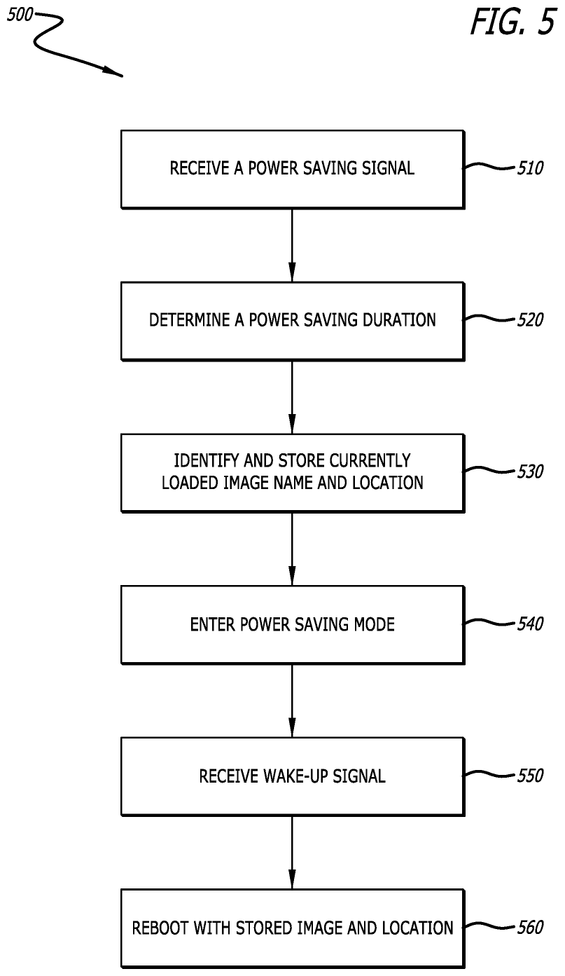

Referring to FIG. 5, a flowchart depicting a process 500 for switching the network device in the hibernation mode or the sleep mode, in accordance with various embodiments of the disclosure is shown. In many embodiments, the process 500 may receive the power saving signal (block 510). In some embodiments, the power saving signal can be indicative of entering the power saving mode. In certain embodiments, the power saving mode may be the sleep mode or the hibernation mode. In some more embodiments, the process 500 may be implemented by the network device. In more embodiments, the power saving signal can be received from the network controller in communication with the network device.

In a number of embodiments, the process 500 can determine the power saving duration (block 520). In some embodiments, the power saving signal can be indicative of the power saving start time and the wake-up time. In certain embodiments, the power saving start time and the wake-up time may be configured by the network controller based on non-peak hours or periods of reduced activity of the network device. In more embodiments, the network controller may facilitate the operator to modify or change the power saving start time and the wake-up time. In some more embodiments, the network controller can also wake-up the network device at any time during the power saving mode by dynamically transmitting the wake-up signal to the network device. In numerous embodiments, the process 500 can initialize the timer based on the power saving duration.

In various embodiments, the process 500 may identify and store currently loaded image name and location (block 530). In some embodiments, the boot image may include a specific set of instructions and data that are essential for booting the network device. In certain embodiments, the boot image can include an initial code required to launch an operating system of the network device and to initiate the one or more functional circuits of the network device. In more embodiments, the boot image may be a currently loaded image when the process 500 receives the power saving signal. In some more embodiments, the process 500 can store the boot image in a memory. In numerous embodiments, the process 500 can determine a memory location corresponding to the saved boot image. In many further embodiments, the process 500 may store the boot image name and the memory location of the boot image in the NVRAM or the EEPROM.

In additional embodiments, the process 500 can switch the network device into the power saving mode (block 540). In some embodiments, the network device may enter the power saving mode. In certain embodiments, the network device can enter the hibernation mode by shutting down all front panel ports and functional circuits. In more embodiments, the network device may enter the sleep mode by shutting down all ports and functional circuits except for the reachable port and the functional circuit associated with the reachable port.

In further embodiments, the process 500 may receive the wake-up signal (block 550). In some embodiments, the process 500 can receive the wake-up signal through the network controller. In certain embodiments, the process 500 may receive the wake-up signal through the timer. In more embodiments, the process 500 may receive the wake-up signal through the mode button.

In many more embodiments, the process 500 can reboot with stored image and location (block 560). In some embodiments, the process 500 can retrieve the boot image name and the memory location from the NVRAM or the EEPROM. Thereafter, in certain embodiments, the process 500 may retrieve the boot image from the memory location. In more embodiments, the process 500 can load and execute the boot image retrieved from the memory. In some more embodiments, the process 500 may reboot the network device based on the boot image. In numerous embodiments, the process 500 can identify the one or more ports or functional circuits that had been shut down. In many further embodiments, the process 500 may restart or initiate the one or more ports or functional circuits.

Although a specific embodiment for the process 500 for switching the network device in the hibernation mode or the sleep mode for carrying out the various steps, processes, methods, and operations described herein is discussed with respect to FIG. 5, any of a variety of systems and/or processes may be utilized in accordance with embodiments of the disclosure. For example, the process 500 may dynamically switch the network device in the hibernation mode or the sleep mode. The elements depicted in FIG. 5 may also be interchangeable with other elements of FIGS. 1-4 and FIGS. 6-9 as required to realize a particularly desired embodiment.

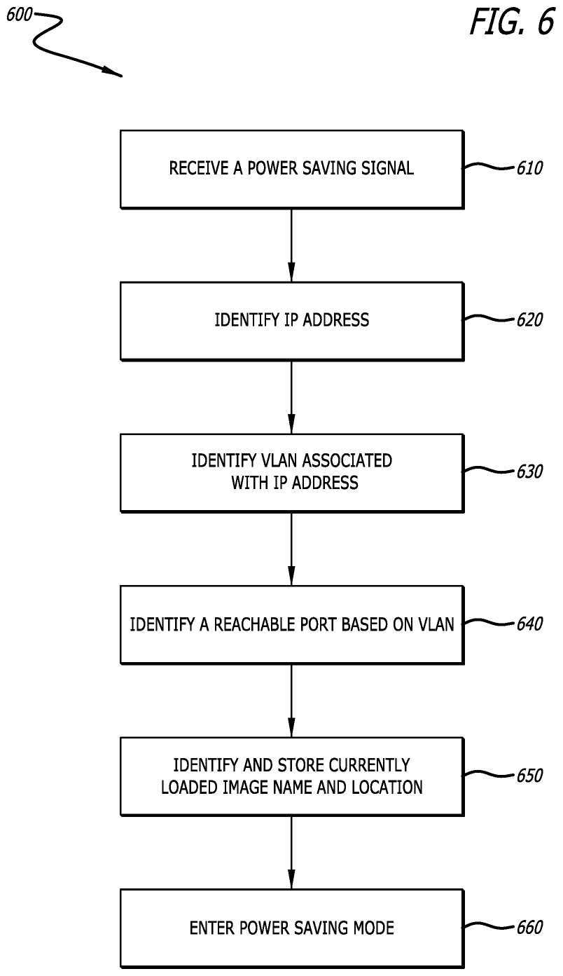

Referring to FIG. 6, a flowchart depicting a process 600 for identifying the reachable port when the network device is in the sleep mode, in accordance with various embodiments of the disclosure is shown. In many embodiments, the process 600 may receive the power saving signal (block 610). In some embodiments, the process 600 can receive the power saving signal from the network device. In certain embodiments, the power saving signal may be indicative of the sleep mode.

In a number of embodiments, the process 600 can identify the IP address associated with the network controller (block 620). In some embodiments, the IP address can be retrieved from telemetry data received by the network device from the network controller. In certain embodiments, the IP address may also be stored in the memory of the network device.

In various embodiments, the process 600 may identify the VLAN associated with the IP address (block 630). In some embodiments, the process 600 may identify the one or more ports associated with the one or more VLANs. In certain embodiments, the one or more ports can be the front panel ports of the network device.

In additional embodiments, the process 600 can identify the reachable port based on the VLAN (block 640). In some embodiments, the process 600 may determine speeds of the one or more ports. In certain embodiments, the process 600 can select the port with lowest speed as the reachable port.

In further embodiments, the process 600 may identify and store the currently loaded image name and location (block 650). In some embodiments, the boot image may include the specific set of instructions and data that are essential for booting the network device. In certain embodiments, the boot image can include the initial code required to launch an operating system of the network device and to initiate the one or more functional circuits of the network device. In more embodiments, the boot image may be the currently loaded image when the process 600 receives the power saving signal. In some more embodiments, the process 600 can store the boot image in the memory. In numerous embodiments, the process 600 can determine the memory location corresponding to the saved boot image. In many further embodiments, the process 600 may store the boot image name and the memory location of the boot image in the NVRAM or the EEPROM.

In many more embodiments, the process 600 can switch the network device into the power saving mode (block 660). In some embodiments, the network device may enter the power saving mode. In certain embodiments, the network device may enter the sleep mode by shutting down all ports and functional circuits except for the reachable port and the functional circuit associated with the reachable port. In more embodiments, the process 600 can further receive the wake-up signal. In some more embodiments, the process 600 may switch to the operational mode from the sleep mode based on the wake-up signal.

Although a specific embodiment for the process 600 for identifying the reachable port when the network device is in the sleep mode for carrying out the various steps, processes, methods, and operations described herein is discussed with respect to FIG. 6, any of a variety of systems and/or processes may be utilized in accordance with embodiments of the disclosure. For example, the process 600 may maintain the Layer 3 connectivity through the reachable port. The elements depicted in FIG. 6 may also be interchangeable with other elements of FIGS. 1-5 and FIGS. 7-9 as required to realize a particularly desired embodiment.

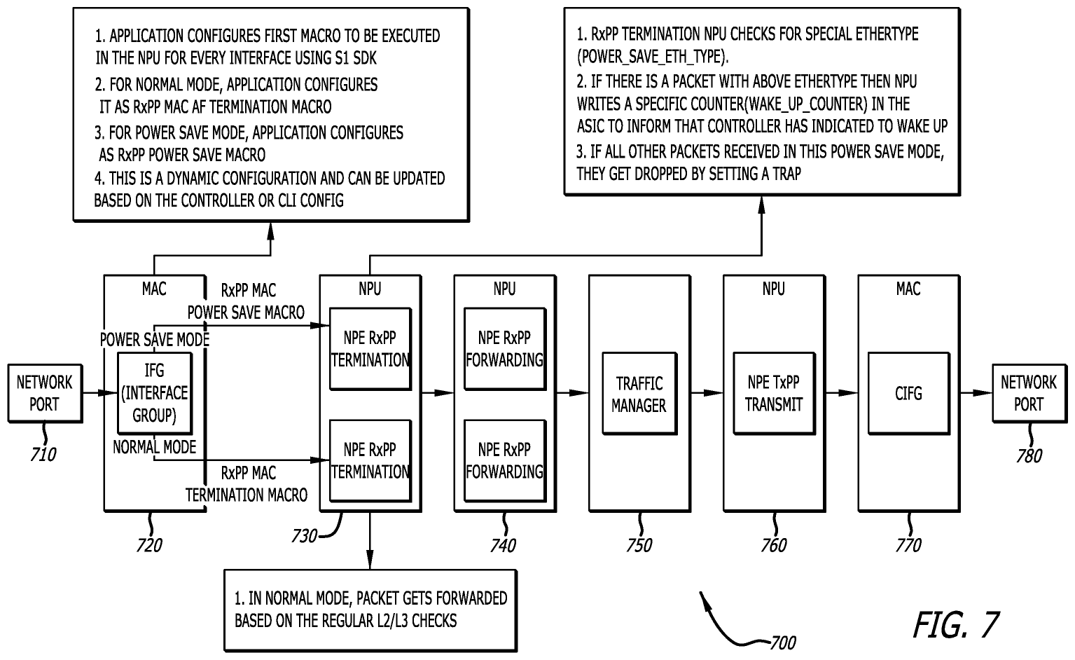

Referring to FIG. 7, a flowchart depicting a process 700 for operating the network device in the power saving mode, in accordance with various embodiments of the disclosure is shown. In many embodiments, the process 700 can receive signals or data packets through a network port of the network device (block 710). In some embodiments, the network port may be the Ethernet port. In certain embodiments, the network port can be the front panel port. In more embodiments, the network port can be associated with a numerical value known as a port number, allowing the data packets to be directed to an appropriate application or a service.

In a number of embodiments, the process 700 may execute a macro (block 720). In some embodiments, the process 700 can configure an S1 Software Development Kit (SDK) to execute a specific macro on the NPU for every interface. In certain embodiments, the process 700 may configure the macro to be Receive Post-Processing (RxPP) MAC Access Function (AF) termination macro when the network device is in the operational mode. In more embodiments, the RxPP MAC AF termination macro can handle the data packets received through the network port when the network device is in the operational mode. In some more embodiments, the process 700 can configure the macro to be RxPP power save macro when the network device is in the power saving mode. In numerous embodiments, the RxPP power save macro may handle the data packets received through the network port when the network device is in the power saving mode. In many further embodiments, the process 700 can dynamically configure the macro based on inputs from the network controller or a Command Line Interface (CLI), thereby providing flexibility in adapting to different operational requirements.

In various embodiments, the process 700 may process the data packets by way of the NPU (block 730). In some embodiments, the NPU can handle the processing of the data packets, including tasks such as packet forwarding, filtering, and routing. In certain embodiments, the NPU may execute the macros. In more embodiments, in the operational mode, while executing the RxPP MAC AF termination macro, the process 700 can forward the data packets based on usual Layer 3/Layer 2 checks.

In many additional embodiments, in the power saving mode, while executing the RxPP power save macro, the process 700 can check for a specific Ethernet frame type (EtherType) known as POWER SAVE ETH TYPE. In some embodiments, the EtherType may be a field in a header of the data packet that can indicate a protocol encapsulated in a frame. In certain embodiments, if the data packet with the abovementioned EtherType is detected, the process 700 can write a specific counter (wake_up_counter) in the ASIC. In more embodiments, the counter may generate the wake-up signal on expiry. In some more embodiments, if other data packets are received in the power saving mode that do not match the abovementioned EtherType, those data packets can be dropped. In numerous embodiments, the process 700 may set a Trap (trp), indicating that these data packets should not be processed or forwarded.

In additional embodiments, the process 700 can process the data packets (block 740). In some embodiments, the process 700 may handle the processing of the data packets, including tasks such as packet forwarding, filtering, and routing. In certain embodiments, the data packets may be dropped in the power saving mode.

In further embodiments, the process 700 may manage the flow of the data packets by way of a traffic manager (block 750). In some embodiments, the process 700 can perform tasks such as but not limited to prioritizing traffic, shaping bandwidth, and ensuring efficient data transmission. In certain embodiments, the process 700 can further perform tasks such as but not limited to prioritizing traffic, shaping bandwidth, ensuring efficient data transmission, implementing traffic policing, managing congestion, and handling buffer management.

In many more embodiments, the process 700 can prepare and send the data packets for transmission by way of the NPU (block 760). In some embodiments, the process 700 may control access to the network ports for transmission through the MAC layer (block 770). In certain embodiments, the process 700 can transmit the data packets through the network port (block 780).

Although a specific embodiment for the process 700 for operating the network device in the power saving mode for carrying out the various steps, processes, methods, and operations described herein is discussed with respect to FIG. 7, any of a variety of systems and/or processes may be utilized in accordance with embodiments of the disclosure. For example, the process 700 may configure the macro to drop the data packets in the power saving mode. The elements depicted in FIG. 7 may also be interchangeable with other elements of FIGS. 1-6 and FIGS. 8-9 as required to realize a particularly desired embodiment.

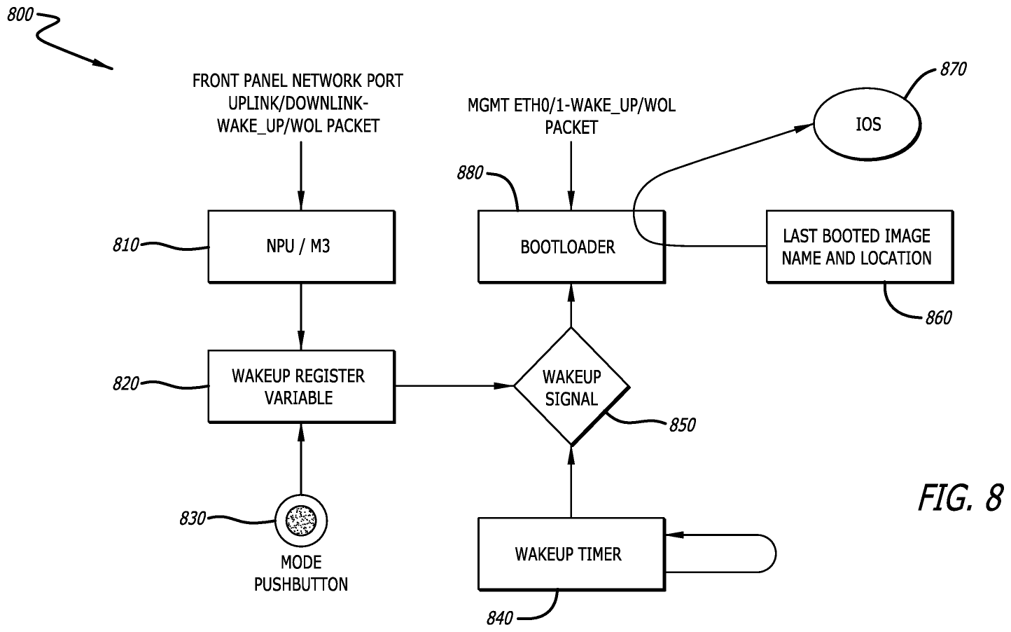

Referring to FIG. 8, a flowchart depicting a process 800 for switching the network device into the operational mode, in accordance with various embodiments of the disclosure is shown. In some embodiments, the process 800 can receive the wake-up signal (block 810). In certain embodiments, the wake-up signal can be received by the network port and forwarded to the NPU. In more embodiments, the wake-up signal may be received through a wake-up (WAKE_UP) data packet received through the front panel network port. In some more embodiments, the wake-up signal may be received through a Wake-on-LAN (WOL) data packet through the front panel network port.

In a number of embodiments, the process 800 may store a wake-up variable value in a wake-up register in memory (block 820). In that, in some embodiments, the wake-up register can be set to put the network device into the operational mode. In certain embodiments, the wake-up register may be reset to put the device into the power saving mode.

In various embodiments, the process 800 can receive the wake-up signal through the mode button (block 830). In some embodiments, the operator of the network device may push the mode button to wake-up the network device. In certain embodiments, the mode button can be a physical button on the front panel of the network device.

In additional embodiments, the process 800 may generate the wake-up signal by way of the timer (block 840). In some embodiments, the power saving signal may be indicative of the power saving start time and the wake-up time. In certain embodiments, the process 800 can determine the power saving duration based on the power saving start time and the wake-up time. In more embodiments, the process 800 may initialize the timer for the power saving duration. In some more embodiments, the timer can generate the wake-up signal upon expiry when the power saving duration ends.

In further embodiments, the process 800 can receive the wake-up signal (block 850). In some embodiments, the wake-up signal can be received by one or more ways: through the front panel network port, through the management port, from the timer, or by the press of the mode button on the network device. In certain embodiments, the wake-up signal can trigger the processor of the network device to switch the network device into the operational mode.

In many more embodiments, the process 800 may retrieve the boot image name and the memory location (block 860). In some embodiments, the boot image name and the memory location can be stored by the network device prior to entering the power saving mode. In certain embodiments, the boot image name and the memory location may be retrieved from the NVRAM or the EEPROM.

In many additional embodiments, the process 800 may retrieve the boot image from the memory location (block 870). In some embodiments, the boot image may correspond to the last loaded boot image. In certain embodiments, the boot image can include the initial code required to launch the IOS.

In still more embodiments, the bootloader may reboot the network device based on the boot image (block 880). In some embodiments, the process 800 can identify the one or more ports or functional circuits that had been shut down. In certain embodiments, the process 800 may restart or initiate the one or more ports or functional circuits.

Although a specific embodiment for the process 800 for switching the network device to the operational mode for carrying out the various steps, processes, methods, and operations described herein is discussed with respect to FIG. 8, any of a variety of systems and/or processes may be utilized in accordance with embodiments of the disclosure. For example, the process 800 may dynamically switch the network device between the operational mode and the power saving mode. The elements depicted in FIG. 8 may also be interchangeable with other elements of FIGS. 1-7 and FIG. 9 as required to realize a particularly desired embodiment.

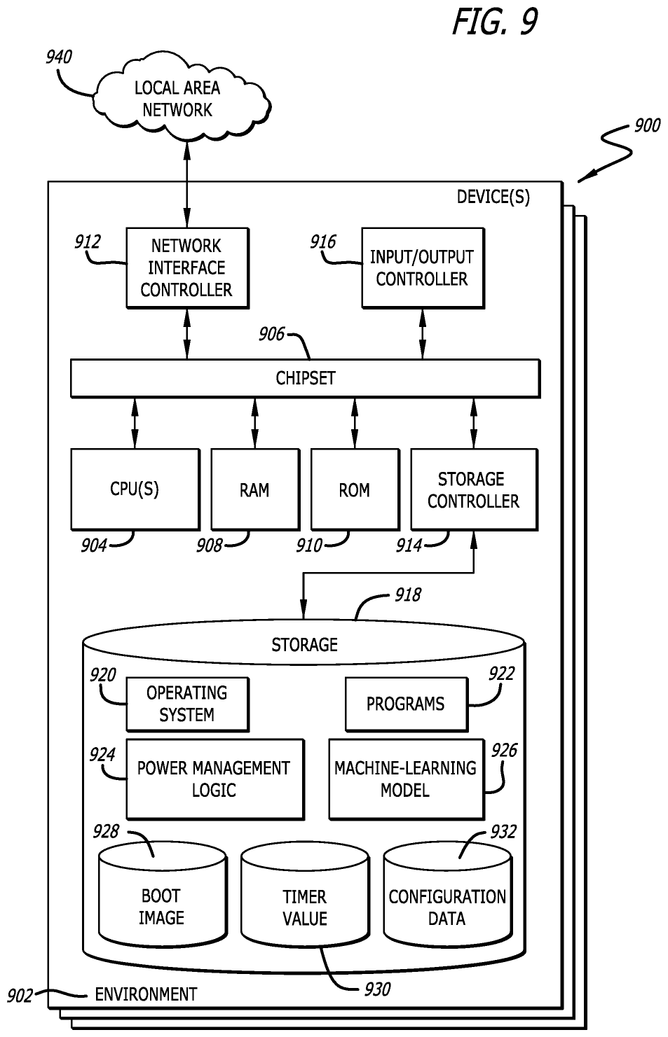

Referring to FIG. 9, a conceptual block diagram of a device 900 suitable for configuration with a power management logic, in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922, boot image 928, timer value 930, and configuration data 932 which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The boot image 928 can store the initial code required to launch the IOS. The timer value 930 may store the power saving mode duration. The configuration data 932 can store the telemetry data including the IP address of the network controller.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In certain embodiments, the device 900 can also include computer-readable storage media having instructions stored thereupon for performing any of the other computer-implemented operations described herein.

In many further embodiments, the device 900 may include a power management logic 924. The power management logic 924 can be configured to perform one or more of the various steps, processes, operations, and/or other methods that are described above. Often, the power management logic 924 can be a set of instructions stored within a non-volatile memory that, when executed by the processor(s)/controller(s) 904 can carry out these steps, etc. In some embodiments, the power management logic 924 may be a client application that resides on a network-connected device, such as, but not limited to, a server, switch, personal or mobile computing device in a single or distributed arrangement. The power management logic 924 can dynamically switch the device 900 or other network devices in the power saving mode.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926.

The ML model(s) 926 can be configured to generate inferences to make predictions or draw conclusions from data. An inference can be considered the output of a process of applying a model to new data. This can occur by learning from at least the boot image 928, the timer value 930, and the configuration data 932 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although a specific embodiment for the device 900 suitable for configuration with the power management logic for carrying out the various steps, processes, methods, and operations described herein is discussed with respect to FIG. 9, any of a variety of systems and/or processes may be utilized in accordance with embodiments of the disclosure. For example, the device 900 may be in a virtual environment such as a cloud-based network administration suite, or it may be distributed across a variety of network devices or switches. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a power management logic, configured to:
receive a power saving signal indicative of entering a power saving mode;
identify a boot image;
determine a memory location associated with the boot image;
shut down one or more components of the device based on the power saving signal to enter the power saving mode;
receive a wake-up signal during the power saving mode; and
retrieve the boot image from the memory location based on the wake-up signal.

2. The device of claim 1, wherein the power management logic is further configured to:
reboot the device based on the boot image; and
restart the one or more components of the device.

3. The device of claim 2, wherein the one or more components include one or more cores of an Application-Specific Integrated Circuit (ASIC) in the device.

4. The device of claim 3, wherein the one or more components include one or more ports of the device.

5. The device of claim 4, wherein the power management logic is further configured to shut down the one or more ports and the one or more cores of the ASIC when the power saving mode is a hibernation mode.

6. The device of claim 5, wherein the wake-up signal is received during the hibernation mode through a management port coupled to the processor.

7. The device of claim 1, wherein the power saving signal is indicative of a power saving start time and a wake-up time.

8. The device of claim 7, wherein the power management logic is further configured to:
determine a power saving duration based on the power saving start time and the wake-up time; and
initialize a timer based on the power saving duration.

9. The device of claim 8, wherein the timer generates the wake-up signal after the power saving duration.

10. The device of claim 1, wherein the power management logic is further configured to identify a reachable port on a front panel of the device.

11. The device of claim 10, wherein the power management logic is further configured to maintain the reachable port in an operational state when the power saving mode is a sleep mode.

12. The device of claim 11, wherein the wake-up signal is received during the sleep mode through the reachable port.

13. The device of claim 12, wherein the power management logic is further configured to:
identify an Internet Protocol (IP) address associated with a controller;
identify one or more Virtual Local Area Networks (VLANs) associated with the IP address;
identify one or more ports associated with the one or more VLANs; and
select one port of the one or more ports having lowest speed as the reachable port.

14. The device of claim 13, wherein the IP address associated with the controller is determined based on a configuration of the device.

15. The device of claim 14, wherein the IP address associated with the controller is retrieved from telemetry data received by the device.

16. The device of claim 1, wherein the wake-up signal is generated by a mode button coupled with the device.

17. A method, comprising:
receiving a power saving signal indicative of entering a power saving mode;
identifying a boot image;
determining a memory location associated with the boot image;
shutting down one or more components of a device based on the power saving signal for entering the power saving mode;
receiving a wake-up signal during the power saving mode; and
retrieving the boot image from the memory location based on the wake-up signal.

18. The method of claim 17, further comprising:
rebooting the device based on the boot image; and
restarting the one or more components of the device.

19. A device, comprising:
a processor;
a memory communicatively coupled to the processor; and
a power management logic, configured to:
receive a power saving signal indicative of entering a power saving mode;
shut down one or more ports of the device based on the power saving signal to enter the power saving mode; and
receive a wake-up signal from a controller during the power saving mode through a reachable port of the one or more ports.

20. The device of claim 19, wherein the power management logic is further configured to:
identify an Internet Protocol (IP) address associated with the controller;
identify one or more Virtual Local Area Networks (VLANs) associated with the IP address;
identify the one or more ports associated with the one or more VLANs;
select one port of the one or more ports having lowest speed as the reachable port; and
maintain the reachable port in an operational state during the power saving mode.
